(19) United States
(12) Patent Application Publication
(10) Pub. No.: US 2022/0067863 A1
(43) Pub. Date: Mar. 3, 2022

(54) VERTIPORT ASSESSMENT AND MOBILITY OPERATIONS SYSTEMS

(71) Applicant: United States of America as Represented by the Administrator of NASA, Washington, DC (US)

(72) Inventors: Kapil S. Sheth, Campbell, CA (US); Parimal Hemchandra Kopardekar, Cupertino, CA (US)

(21) Appl. No.: 17/133,424

(22) Filed: Dec. 23, 2020

Related U.S. Application Data
(60) Provisional application No. 63/073,948, filed on Sep. 3, 2020.

(51) Int. Cl. G06Q 50/26; G06Q 30/02; G06Q 30/00; G06Q 10/06

(52) U.S. Cl. CPC G06Q 50/26; G06Q 10/06315; G06Q 30/018; G06Q 30/0205

(57) ABSTRACT

Identifying geographical locations suitable for a vertiport. Suitability factors across a geographical area are identified for consideration including, without limitation, noise, zoning, transit stations, fire stations, and hospitals. The suitability factors have suitability values that are based on characteristics, including location-based suitability values (i.e., proximity to mass transit stations), level-based suitability values (i.e., noise levels), and characteristic-based suitability values (i.e., residential zoning). The vertiport assessment system divides the geographical area into subregions, identifies a set of candidate vertiport locations using suitability values, weights for scaling the impact of the suitability factor, and identifies a particular subregion as a candidate location if a composite value exceeds a threshold value. The candidate subregions are shown on a user interface map overlay in a color-coded gradient that reflects the composite values for a subregion. These candidate vertiport locations are refined by establishing feasibility of flight between them.

### CLAIM OF PRIORITY

The present application claims priority to U.S. Provisional Patent Application No. 63/073,948, entitled “Vertiport Assessment and Mobility Operations System (VAMOS),” filed Sep. 3, 2020, the entire disclosure of which is hereby incorporated by reference for all purposes in its entirety as if fully set forth herein.

### ORIGIN OF THE INVENTION

The invention described herein was made by employees of the United States Government and may be manufactured and used by or for the Government of the United States of America for governmental purposes without the payment of any royalties thereon or therefor.

### FIELD OF THE INVENTION

Embodiments of the invention generally relate to software for assessing the location, impact, and use of potential and actual vertiport locations across geographical areas.

### BACKGROUND

The term Urban Air Mobility (UAM) vehicle refers to a new mode of transportation utilizing airborne vehicles, for transporting goods and/or people. Non-limiting, illustrative examples of a UAM vehicle include a drone, an airborne taxi, an airborne medical transport, and an airborne evacuation transport. Another example of a UAM vehicle is an electric Vertical Take Off and Landing (eVTOL) vehicle; it should be noted that the concept of a UAM vehicle, as used herein, is independent of any particular power source (such as electrical, chemical, nuclear, and so on) and includes a variety of modes of flight (such as rotary blades, fixed wings, hot air balloon, and so on).

Drones are currently being considered for use in delivering goods to consumer's doorsteps and are widely used in surveillance and surveyance operations. In the future, the manner by which large populations of people commute to work, travel, receive goods and services, enact healthcare, and ensure public safety will likely become dependent upon UAM vehicles in some form. It is widely believed the field of UAM vehicles is poised to have a significant societal impact in the coming years.

While the technology implementing UAM vehicles evolves, certain requirements are clear at present. The adoption of widespread use of UAM vehicles will necessitate a plurality of vertiports located throughout a geographical region. A vertiport, as used herein, refers to a physical structure for the departure, arrival, or parking/storage of one or more UAM vehicles. The role played by a vertiport is similar to that of a train station, as a vertiport is the location at which passengers may embark and disembark, or at which goods may be loaded or unloaded, but for a UAM vehicle rather than a train.

In the same way that a city planner must identify a good location for a train station prior to its construction, city planners and other administrators will need to identify locations at which vertiports may be built. Unfortunately, no mechanisms or tools exist in the art to assist in this endeavor.

### BRIEF DESCRIPTION OF THE DRAWINGS

Embodiments of the invention are illustrated by way of example, and not by way of limitation, in the figures of the accompanying drawings and in which like reference numerals refer to similar elements and in which:

FIG. 1 is a block diagram of a system depicting vertiport assessment software in accordance with an embodiment of the invention;

FIG. 2 is an illustration of an exemplary user interface showing a geographical area displayable on a client in accordance with an embodiment of the invention;

FIG. 3 is an illustration of an exemplary user interface showing the geographical area with rail stations marked in accordance with an embodiment of the invention;

FIG. 4 is an illustration of an exemplary user interface showing the geographical area with power grid lines marked in accordance with an embodiment of the invention;

FIG. 5A is a graph depicting how particular suitability values may vary based on location in accordance with an embodiment of the invention;

FIG. 5B is a graph depicting how particular suitability values may vary based on suitability factor characteristics in accordance with an embodiment of the invention;

FIG. 6 is an illustration of an exemplary user interface showing a geographical area with a gradient overlay depicting suitability values of rail stations in accordance with an embodiment of the invention;

FIG. 7 is an illustration of two graphs showing ground congestion suitability criteria according to an embodiment of the invention;

FIG. 8 is an illustration of a user interface showing candidate vertiport locations in a geographical area in accordance with an embodiment of the invention;

FIG. 9 is an illustration of a user interface showing candidate vertiport locations in a geographical area that satisfy a different suitability threshold value than FIG. 8 in accordance with an embodiment of the invention;

FIG. 10 is an illustration of a user interface employed by a simulation component to analyze whether the flight paths of airborne vehicles and devices are obstructed in accordance with an embodiment of the invention;

FIG. 11 is an illustration of a user interface employed by a simulation component that depicts the flight paths of airborne vehicles and devices in operation in accordance with an embodiment of the invention; and

FIG. 12 is a block diagram that illustrates a computer system upon which software performing one or more of the steps or functions discussed herein may be implemented.

### DETAILED DESCRIPTION OF THE INVENTION

Approaches for programmatically identifying one or more geographical locations suitable to host a vertiport are presented herein. Embodiments also provide for assessing the impact and use of potential and actual vertiport locations across geographical regions. In the following description, numerous specific details are set forth to provide a thorough understanding of the embodiments of the invention described herein. It will be apparent, however, that the embodiments of the invention described herein may be practiced without these specific details. In other instances, well-known structures and devices are shown in block diagram form or discussed at a high level to avoid unnecessarily obscuring teachings of embodiments of the invention.

Embodiments of the invention involve airborne devices and/or airborne vehicles. It is observed that various names in the art have been used to describe airborne devices and vehicles, and other terms are likely to be used in the future. As broadly used herein, the term “xAM” vehicle refers to an umbrella term to describe a range of aircraft, including manned or unmanned airborne devices or airborne vehicles capable of using a vertiport. Non-limiting, illustrative examples of a xAM include any type of drone, an Urban Air Mobility (UAM) vehicle, an Advanced Air Mobility (AAM) vehicle, and a Regional Air Mobility (RAM) vehicle. Non-limiting, illustrative examples of the responsibilities an xAM vehicle may perform include a distributor of goods or services, a medical evacuation transport (such as used to transport a human patient or a pet to a hospital), a rescue transport (such as used to transport a human or animal out of the area, e.g., to escape a fire, flood, or other natural disaster), and a taxi (such as used to transport a small number of people to a different vertiport).

A vertiport, as used herein, refers to a physical site at which an xAM vehicle may arrive, depart, park, or be maintained/serviced. A vertiport may also perform recharging and maintenance services for a xAM.

### Functional Overview

Embodiments of the invention are directed towards software that executes upon physical hardware. The software of an embodiment is collectively referred to as vertiport assessment software. Vertiport assessment software of an embodiment may be composed of any number of functional components, or modules, which each perform one or more functions discussed herein. Embodiments may be implemented as a singular unit of software or a collection of modules designed to operate together as a functional whole.

In an embodiment, vertiport assessment software may include a modeling component and a simulation component. The modeling component is directed towards assisting a user to identify one or more geographical locations at which a vertiport may be physically built. The modeling component may be used, for example, by a city planner or a government body for purposes of city planning

The simulation component of an embodiment may be used to model and manage the flight paths of a plurality of xAM vehicles across a city or other geographical area. The simulation component may simulate and monitor the flight paths of xAM vehicles flying between vertiports, both actual and potential. The simulation component may also display, in real-time, the present location and operational behavior of xAM vehicles in the context of their projected flight paths in accompaniment with data dynamically obtained from live sources, such as, without limitation, from the Federal Aviation Administration (FAA) or other private or public governing body, from one or more xAM vehicles in flight, and from weather sources.

### System Overview

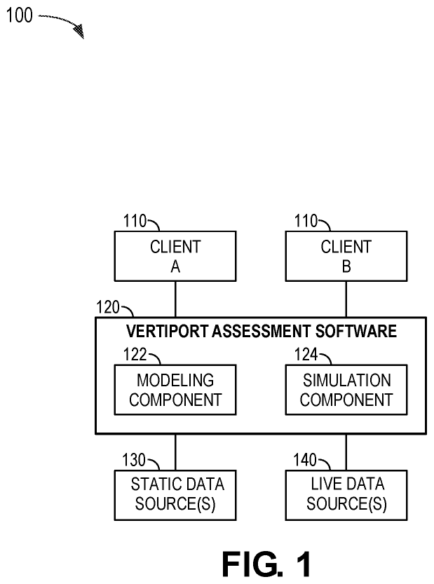

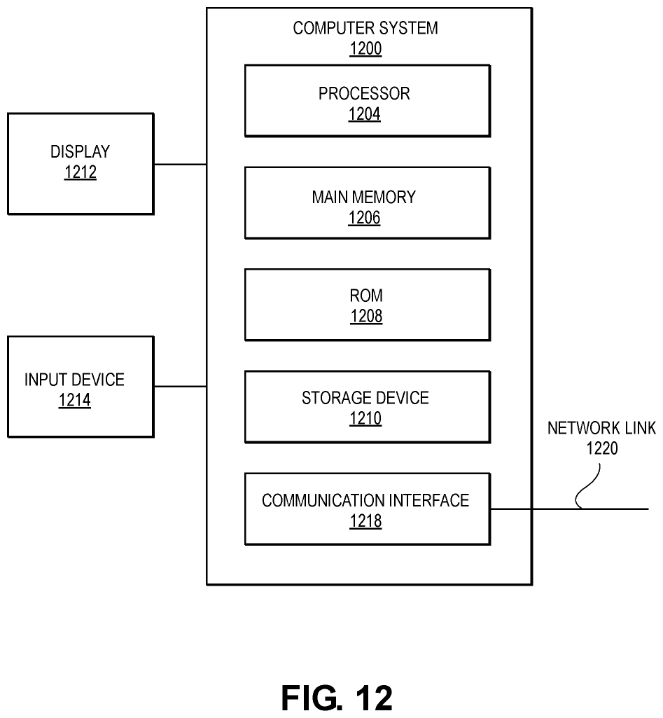

FIG. 1 is a block diagram of a system 100 depicting vertiport assessment software in accordance with an embodiment of the invention. The functional components depicted by FIG. 1 correspond to software and/or digital data sources that are maintained by physical hardware, such as a computer system. While the physical hardware required to execute or maintain such software and data are not depicted in FIG. 1, such physical hardware is described below with reference to FIG. 12.

FIG. 1 depicts vertiport assessment software 120, two clients 110, static data source(s) 130, and live data source(s) 140, each of which may be accessible over a network such as a local area network (LAN), an Intranet, or a public network, e.g., the Internet. Vertiport assessment software 120 may be, but need not be, implemented as part of a cluster for fault-tolerance and scalability purposes.

An embodiment of vertiport assessment software 120 may comprise modeling component 122 and simulation component 124, both of which may interact with and inform the operation of the other. For example, a user may use a particular client 110 to interact with modeling component 122 to define the location of a plurality of vertiports, using a process that shall be described in detail below. The user may cause modeling component 122 to provide as input the defined locations of the plurality of vertiports to simulation component 124. The user may thereafter use simulation component 124 to simulate the flight paths of xAM vehicles flying between the vertiports defined by modeling component 122. Simulation component 124 may identify an issue with one or more of the chosen vertiport locations, which can be resolved by the user selecting a different site for those vertiport locations using modeling component 122.

Client 110 represents any software capable of accessing and interacting with vertiport assessment software 120 or any component thereof. While FIG. 1 depicts two clients, embodiments may employ any number of clients 110. A client 110 may be embodied as an application that executes on an operating system. For example, a client 110 may be embodied by a web browser that retrieves and displays a web page associated with vertiport assessment software 120. The web page may invoke functions performed by vertiport assessment software 120. In some embodiments, client 110 may be embodied by a mobile application that provides a user interface for interfacing with vertiport assessment software 120 that is hosted on the cloud. While FIG. 1 shows vertiport assessment software 120 as separate from client 110, it is understood by those of skill in the art that portions of vertiport assessment software 120 may be embodied in a client software, such as a computer application or a mobile application, without departing from the scope or spirit of the invention.

Static data source(s) 130 and live data source(s) 140, as broadly used herein, both refer to data sources that store digital data considered or accessed by vertiport assessment software 120. Static data source(s) 130 refer to data sources that, while providing information that is capable of being updated, are generally providing data that is static in nature, such as geographic features, infrastructure, road map data, county lines and other regional borders, Light Detection And Ranging (LiDAR) data, zoning boundaries, physical structures, points of interest, and the like. Static data source(s) 130 may include aerial maps that are periodically updated but need not be updated frequently. Similarly, static data source(s) 130 may include information about the three-dimensional shape, height, and footprint of buildings that can updated but need not be done so frequently.

Live data source(s) 130 refer to data sources that are updated with some amount of frequency, such as information concerning surface and air traffic conditions, weather, dynamic ground or air conditions, and the like. Live data source(s) 130 may receive timely or periodically updated information from sources such as the FAA, the National Weather Service, real-time surface and air traffic information from providers such as Google Maps, and operational data reported from xAM vehicles currently being operated.

Static data source(s) 130 and live data source(s) 140 may store or provide information used in determining whether a particular physical location is suitable for a vertiport. Vertiport assessment software 120 may access data stored in static data source(s) 130 and/or live data source(s) 140 to assess the viability and suitability of different physical locations across a large geographical region with respect to hosting a vertiport.

### Suitability Factors

The information stored within or provided by static data source(s) 130 and/or live data source(s) 140 may be organized and/or evaluated by vertiport assessment software 120 as a series of suitability factors. Each suitability factor corresponds to a characteristic that can affect the suitability of a particular physical location for hosting a vertiport.

Non-limiting, illustrative suitability factors include: activity centers (such as amusement park, zoos, art museums, and the like), airports, classes of airspace (such as class B, and the like), bicycle parking and storage stations, bus stops (including local bus stops, regional bus stops, and express bus stops), cell towers, convention centers, dams, daycare centers, transportation demand data (including average origin/destination trip demand and binned spatial/temporal data), endangered species areas, fire codes, fire stations, flood plain zones, heliports, hurricane evacuation zones, evacuation routes, land use (both existing and future), large obstacles (for example, objects over 300 feet in height), mass transit stations, medical centers, medium obstacles (for example, object under 300 feet in height), military areas, mobility/multi-modal centers, opportunity zones, parking lots, parks, places of worship, police stations, ports, potential vertiport loci, power grid, power plants, railroad and rail hubs, rail stations, reinvestment zones, restricted airspace, schools, shopping malls, socioeconomic areas, sport venues, storm surge zones, streetcars, surface traffic (including average traffic density and binned spatial/temporal data), universities, vacant lots, vertiport background noise, water (e.g., rivers, lakes, streams, and the like), and zoning.

Information stored by the system 100 about suitability factors includes information about the incidence of the suitability factors at various physical locations across a geographic area, information about the levels of the suitability factors present at various locations, or information about how the suitability factors applies to a location by assignment of suitability values. For example, and as will be further discussed, location-based suitability factors, such as train stations, includes information about the location of the train stations, and therefore the distance of the train station from a particular location is also able to be determined by the system, and suitability values as a function of the distance of the train station from the target location. In some embodiments, certain suitability values for location-based suitability factors are a function of estimated travel time by various surface transportation modes. Certain suitability factors are characteristic-based, for example, the zoning suitability factor includes codified zones, such as commercial and residential, as well as other recognized zones, such as districts or neighborhoods. Still others of the suitability factors are level-based, such as noise and traffic suitability factors, that are based on the decibels observed, the cars-per-minute observed, or the traffic index, which based on an observed travel time as compared to an expected travel time with free-flowing traffic, for the geographic area.

Suitability factors may be assigned a configurable weight by the user. In this way, each suitability factor may be treated by vertiport assessment software 120 in accordance with its perceived importance by the user when assessing the suitability of a particular location for a vertiport.

### Identifying Candidate Locations in a Geographical Area

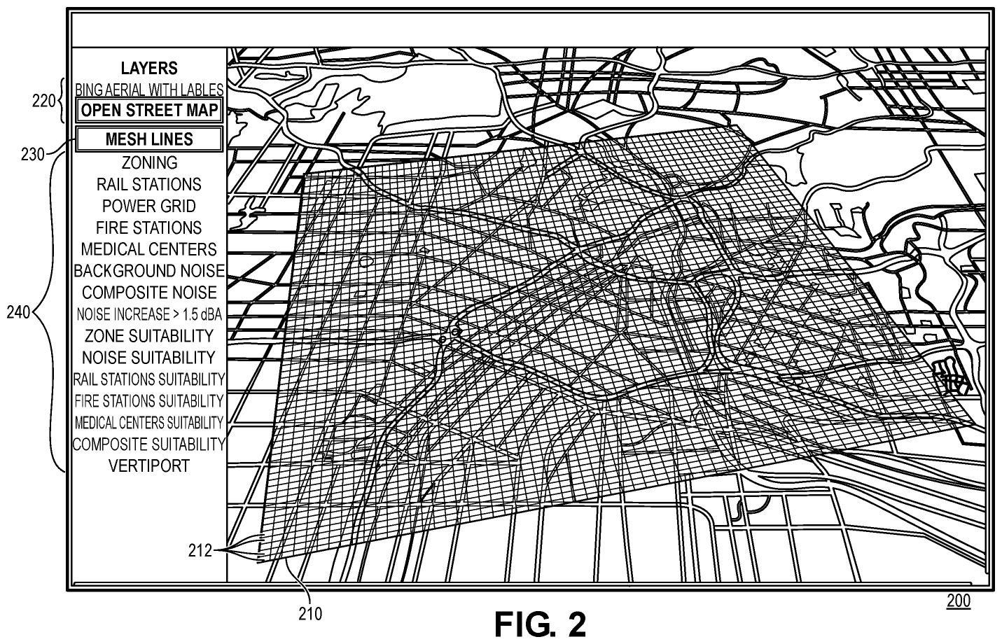

FIG. 2 is an illustration of an exemplary user interface 200 showing a geographical area displayable on client 110 in accordance with an embodiment of the invention. In the example of FIG. 2, user interface 200 corresponds to a web page displayed by a web browser. In some embodiments, user interface 200 corresponds to a user interface of a mobile device application. User interface 200 may depict features of a geographical area, such as a city, town, or population of people centered in a particular region. User interface 200 may do so by depicting a map, picture, three-dimensional representation, a satellite image, or anything that visually represents a geographical area. Certain embodiments allow for the visual representation for the geographical area to be toggled between different display modes, such as two-dimensions, three-dimensions, overhead, angled, aerial view, augmented reality (AR), virtual reality (VR), and the like. Such an adjustment to the display of user interface 200 may be performed by the user selecting one of user interface (UI) controls 220 or using a similar mechanism to submit instruction to modeling component 122.

User interface 200 allows the user to select a particular geographical area to view, e.g., the user may select a city on a map or select a particular geographical area from a set of options. User interface 200 may allow the user to zoom in and out of the depicted geographical area or adjust the camera perspective of the display.

User interface 200 may use information obtained from static data source(s) 130 to determine how to display the desired geographical area. Such information may include physical features, such as lakes, rivers, mountains, hills, and the like, as well as man-made features, such as buildings, roads, county lines and other regional borders, LiDAR data, zoning boundaries, jurisdiction boundaries, and so on.

In addition to depicting the physical landscape of the desired geographical area, the user may instruct user interface 200 to update the display to show information pertaining to one or more selected suitability factors. For example, a user may select one of UI controls 240 to cause the display of user interface 200 to be updated to display information about a variety of suitability factors.

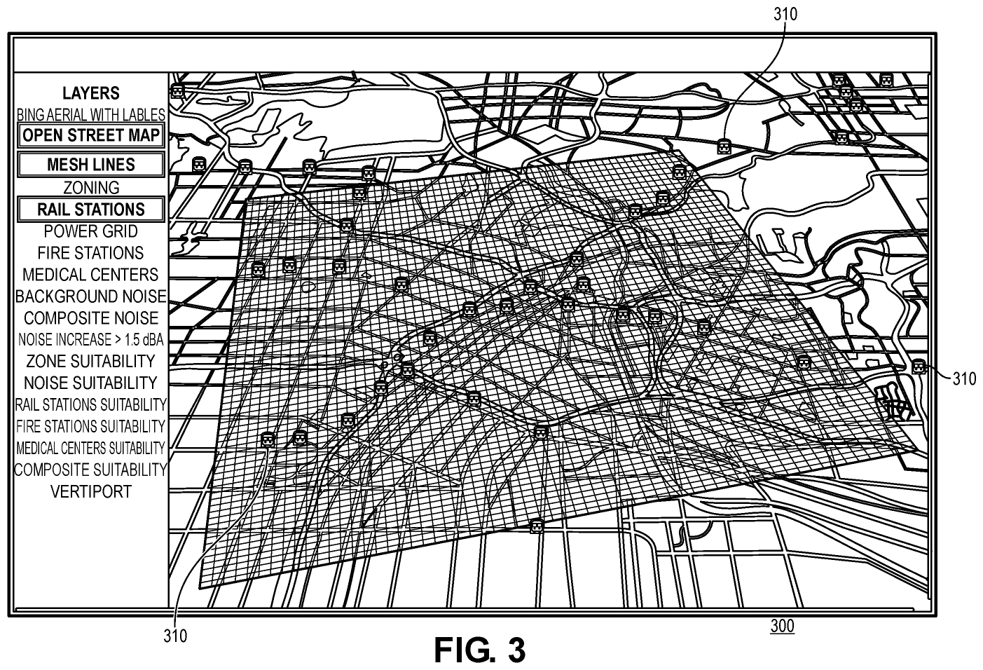

For example, consider FIG. 3, which is an illustration of an exemplary user interface 300 showing the geographical area marked with the locations of rail stations 310, which are a suitability factor considered for assessing a location for a vertiport, in accordance with an embodiment of the invention. User interface 300 depicted by FIG. 3 might be displayed, for example, in response to receiving input from a user selecting the link or UI control ‘Rail Station’ depicted as part of UI control 240 on FIG. 2.

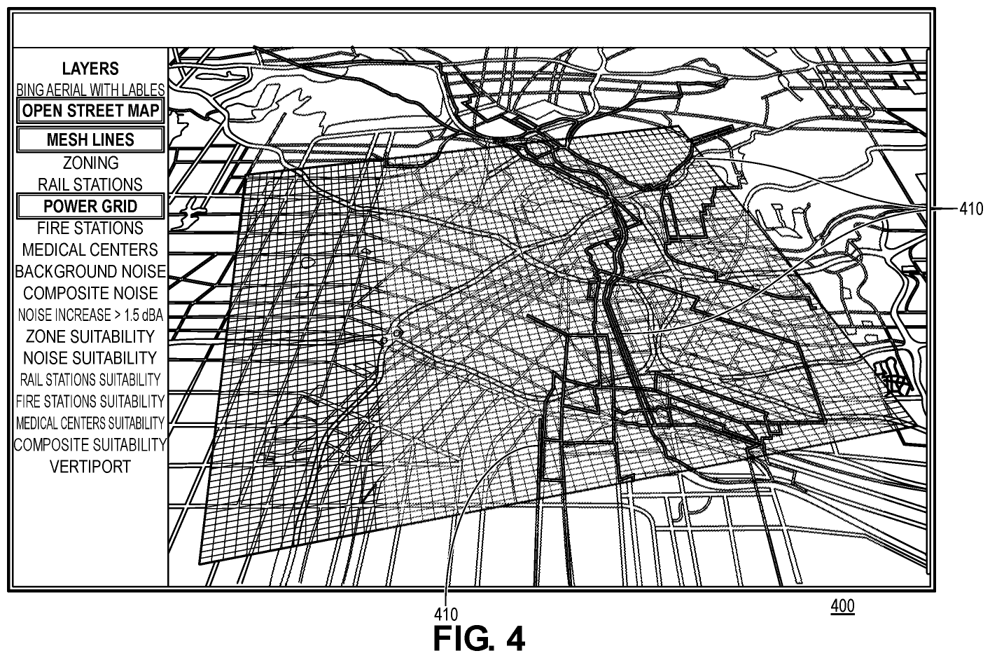

As another example, FIG. 4 is an illustration of an exemplary user interface 400 showing the geographical area with power grid lines 410 in accordance with an embodiment of the invention. User interface 400 depicted by FIG. 4 might be displayed, for example, by the user selecting the link or UI control ‘Power Grid depicted as part of UI control 240 on FIG. 2.

Modeling component 122 allows the user to identify locations in the geographical area that are well suited for a vertiport. Such locations are referred to as ‘candidate locations’ herein. A candidate location is a potential location identified by modeling component 122 for where a vertiport might be located. In some embodiments, modeling component 122 presents information about which locations in the geographical area are well suited for a vertiport (i.e., all the candidate locations), after which the user may then identify, using the user interface provided by modeling component 122, a set of physical sites (identified by latitude and longitude coordinates) at which one or more vertiports may be built.

In an embodiment, a user may request modeling component 122 to update the display of user interface 200 to depict a set of candidate locations. To determine what locations in the geographical area are candidate locations, through input received via user interface 200, modeling component 122 may cause user interface 200 to display a grid 210 overlain or superimposed over the geographical area. For example, FIG. 2 depicts grid 210 overlaying a geographical region. The user may cause grid 210 to be displayed over the geographical area depicted by user interface 200 by selecting the UI control 230 or by using a similar mechanism.

In some embodiments, grid 210 divides the geographical region shown in user interface 200 into a plurality of subregions, or cells 212. Cells 212 may be equal sized in certain embodiments but need not be the same size or even the same shape in other embodiments. The subregions bounded by these cells 212 will be evaluated by modeling component 122 to determine whether the particular subregion is a suitable location for a vertiport, i.e., whether the region within the cell is a candidate location.

In an embodiment, the size and/or shape of each cell may be (a) customized or configured by the user or (b) may be based on population size or density or some other characteristic that impacts the granularity of the candidate location assessment. For example, large tracts of open land may be represented by a single cell 212 of relatively larger size compared to a more densely populated area. Thus, embodiments may adapt the size and/or shape of cells 212 upon, for example, population density of the land represented thereby.

In some embodiments, each cell is a potential candidate location. In such embodiments, the user may wish to adjust the dimensions of each cell to encompass the boundary of a suitable building site for a vertiport. For example, a user operating a private package delivery operation may wish to consider candidate locations that are roughly the size of a building, whereas another user operating a public transit operation might wish to consider candidate locations that are roughly the size of a city block. To provide a concrete example, each side of grid 210 might measure roughly 7 miles in length having 200 rows or columns of cells 210. In this example, each cell 212 represents a square having each size about 55 meters or 185 feet in length. In some embodiments, the length of each side of grid 210 and the number of cells 212 in each row/column of the grid is modifiable by the user so that each cell 212 defines a physical area of the desired size.

The user may evaluate any geographical area using grid 210, as grid 210 is relocatable to any region and may be resized as desired. When instructed by the user to evaluate the geographical area covered by grid 210 for recommendations for candidate locations, modeling component 122 will determine a set of weighted values for each cell 212 of grid 210. In some embodiments, each weighted value is determined from multiplying a suitability value with a corresponding scale value. In some embodiments, each suitability value is associated with a different suitability factor and each scale value is a separate value used to scale the suitability value to arrive at the weighted value. For each cell 212, modeling component 122 calculates a weight mean from all weighted values associated with the suitability factors considered for that cell 212 to result in cell 212's composite suitability value for the suitability factors.

For a given cell 212, the suitable value of a suitability factor will depend upon the suitability factor characteristics of the area defined by that cell 212. Those characteristics may be measured or known and recorded in static data source(s) 130 and/or live data source(s) 140. For example, the ground noise associated with a physical area associated with each cell 212 may be measured and stored as part of static data source(s) 130 and/or live data source(s) 140. This information is used to determine the ground noise suitability value of each cell 212.

In an embodiment, suitability values for each cell 212 may be expressed as a value ranging from −1 to 1. In such an embodiment, suitability values ranging from −1 to 0 serve as a deterrent for a cell 212 to be found suitable to be a candidate location, while suitability values ranging from 0 to 1 serve to encourage a cell 212 to be found suitable to be a candidate location. For this reason, suitability values of −1 to 0 may be referred to as a penalty while suitability values of 0 to 1 may be referred to as a reward. In some embodiments, the suitability values are expressed as a value ranging from 0 to 1. The determination of whether a particular suitability factor should serve as a reward or a penalty depends upon the nature of the suitability factor. For example, because it is undesirable to have a vertiport near a school or a place of worship, and the proximity of a school or a place of worship to a particular cell 212 acts as a penalty. On the other hand, it is desirable to have a train station or a fire station near a vertiport, and so the proximity of a train station or a fire station to a particular cell 212 acts as a reward.

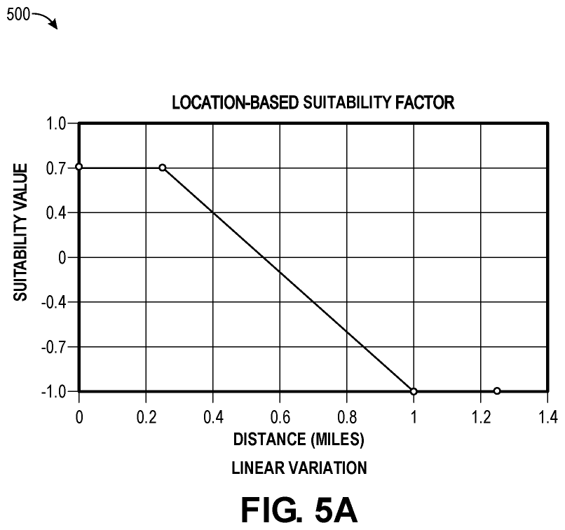

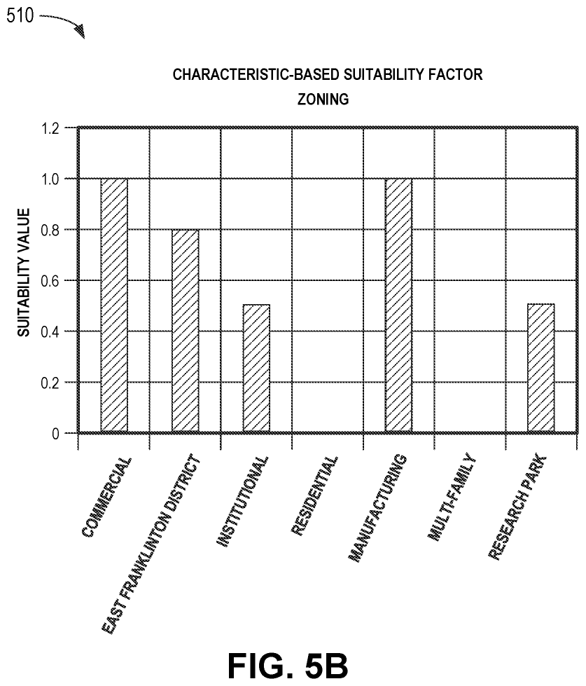

In this way, suitability values are dependent upon one or more characteristics associated with the suitability factor, including distance, travel time, frequency, or descriptive characteristics. FIG. 5A is a graph depicting how particular suitability values may be location-based, with suitability values as a function of distance, in accordance with an embodiment of the invention. In some embodiments, the location-based suitability factor is associated with suitability values determined as a function of travel-time. As shown in FIG. 5A, for certain suitability factors, such as power grids and fire stations, the suitability value of a particular cell 212 is a function of how far the area defined by each cell 212 is from the power grid's or fire station's location. In some embodiments, for a particular suitability factor selected to be considered for assessing the vertiport suitability of over a geographic area, the suitability function for the suitability factor, such as one shown in FIG. 5A, is applied to every cell 212 in grid 210 determine the suitability value for each cell for grid 210.

Suitability values assigned to a particular cell 212 are based on the composite of particular characteristics of the particular suitability factors selected to be considered for the particular cell 212, such as a railway station or a daycare facility. Certain suitability factors yield a greater suitability value when the suitability factor is present in abundance or located relatively close, while other suitability factors yield a greater suitability value when the suitability factor is barely present or located relatively far way. As a result, the suitability graph shown in FIG. 5A is merely an example of an embodiment for a single suitability factor. Other embodiments may employ different approaches for determining the suitability for the suitability factor shown in FIG. 5A. Embodiments may employ a wide variety of approaches for determining the suitability value of a particular cell 212 for a suitability factor, including using one or more of a linear function, a step function, a gaussian function, a quadratic expression, and decaying values, or any regular or irregular expression.

Certain suitability values are dependent upon particular descriptive characteristics or categories associated with the suitability factor. FIG. 5B is a graph 510 depicting how particular suitability values may vary based on suitability factor characteristics in accordance with an embodiment of the invention. As shown in FIG. 5B, for certain suitability factors, such as zoning and reinvestment zones, suitability values are a function of the characteristics or categories associated with the particular suitability factor. For example, the zoning types of a particular geographic region includes commercial zones, institutional zones, residential zones, manufacturing zones, and multi-family home zones. While the zoning for system 100 may correspond with codified zoning laws, other zones may be defined for system 100, such as neighborhood districts or types of property. For example, a city like Columbus, Ohio, may define a zone as East Franklinton District, or a research park. In this example, each particular cell 212 for grid 210 for the Columbus area is within or corresponds to a zone, and each zone corresponds to a pre-defined suitability value. Accordingly, here, a particular cell 212 may have a suitability value of 1.0 because it is in a commercial zone. Similarly, another characteristic-based suitability factor type is the reinvestment zone type, which may have the characteristics of being Market-Ready, Ready for Opportunity, Ready for Revitalization, or Not Reinvestment Zone.

Reinvestment Zone
Suitability Factor

| Suitability | Suitability |
|---|---|
| Factor Characteristic | Value |
| Market-Ready | 1.0 |
| Ready for Opportunity | 0.75 |
| Ready for Revitalization | 0.5 |
| Not Reinvestment Zone | 0 |

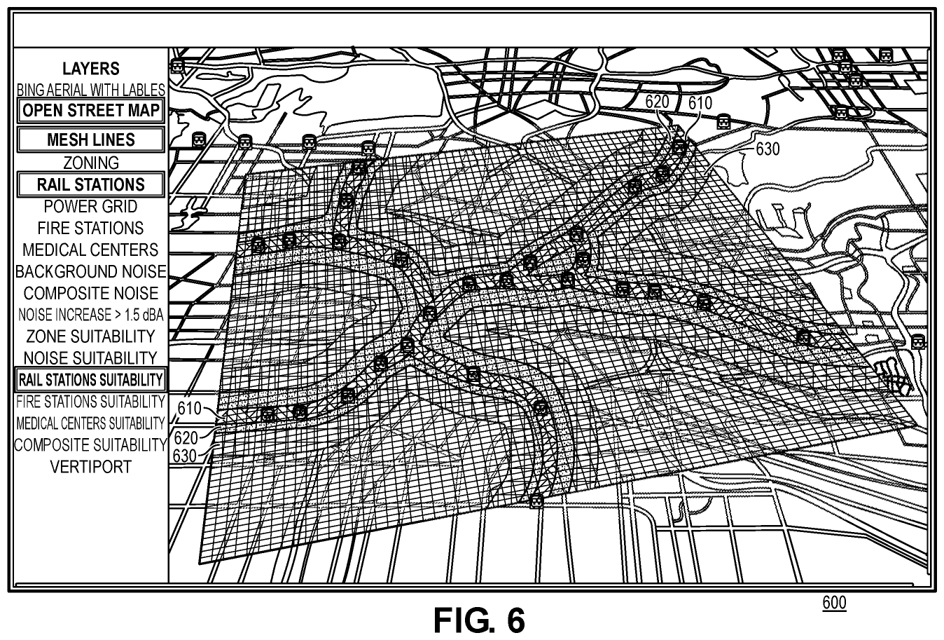

To illustrate these principles in practice, consider FIG. 6, an illustration of an exemplary user interface showing a geographical area with a gradient depicting suitability values of rail stations in accordance with an embodiment of the invention. User interface 600 of FIG. 6 depicts the geographical area with the locations of rail stations similar to FIG. 3, but user interface 600 shows areas 610, 620, and 630, each within a gradient range based on the suitability value of rail stations in those areas. In some embodiments, cells 212 in each of areas 610, 620, and 630 are assigned a suitability values based on application of a rail station suitability factor function to each of the cells in grid 210. While this example shows three discrete suitability values assigned each of the areas 610, 620, 630, in practice, the suitability values may be in a continuous range of values, depending on the suitability function defined for the particular suitability factor. In some embodiments, the suitability values for different suitability factors may be normalized, for example, between −1 and 1, so that they may be readily combined as a composite.

Embodiments may depict the suitability value associated with each cell 212 using a heatmap or other approach for depicting a color gradient of varying suitability values. While the figures referenced herein are drawn as black lines that are incapable of showing gradient, embodiments of the invention employ gradients of color hues, saturation, brightness, and transparency to correspond to suitability values. For example, a suitability value scale is colored along a gradient of a hue of green, ranging in brightness from light green to dark green, with the light green end of the scale corresponding to a suitability value of −1, and the dark green end of the scale corresponding to a suitability value of 1. In another example, one end of a scale is in dark blue, with a gradient into red on the other end of the scale, for greater color contrast and representation of “hot” (red) and “cold” (blue) subregions. In still another example, the scale is a gradient from colors of the shortest wavelength to longest wavelength, resulting in a rainbow scale. The particular color schemes chosen to represent values may be modifiable across embodiments to support user preference and accessibility.

In some embodiments, suitability factors are level-based, such as noise, traffic congestion, and population density. Such suitability factors are associated with suitability functions where suitability values are a function of decibels, cars-per-minute, and residents-per-square-mile, respectively.

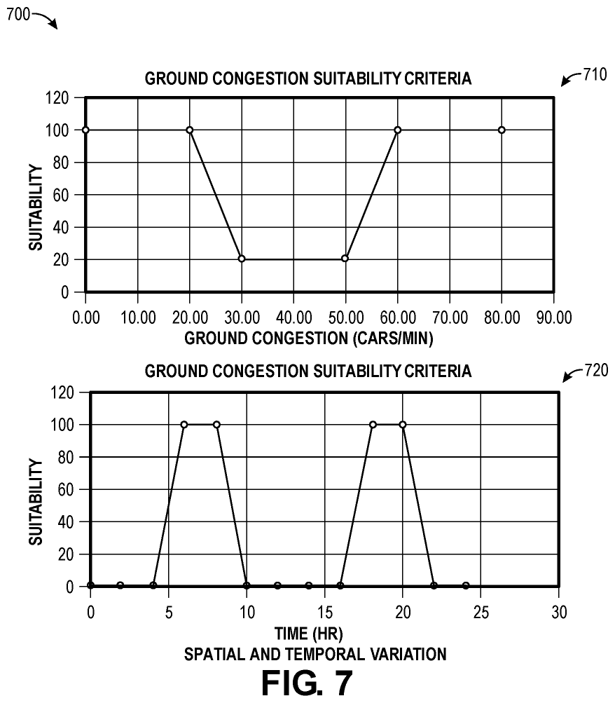

In an embodiment, a suitability value for a particular cell 212 may vary based on time of day. To illustrate, consider FIG. 7, which is an illustration of graphs of function 710 and function 720 that each show ground congestion suitability criteria or factor according to an embodiment of the invention. Graphs 710 and 720 show spatial and temporal variation in the suitability of a location based on the ground congestion in the vicinity of probable location of a vertiport. Thus, embodiments of the invention can determine the suitability for a candidate location for different hours of operations. Indeed, embodiments of the invention can programmatically determine the hours of operation during week a particular candidate location is deemed sufficiently suitable to host a vertiport location so that this information may inform its hours of operation during actual practice or use.

In an embodiment, the suitability of a particular cell 212 is assessed using an approach that considers a plurality of suitability factors. For example, a weighted mean may be used to determine a composite suitability value for a particular cell 212. For example:

$$Composite {suitability}_{cell} = \frac{\sum ( {W}_{i} \times {S}_{i} )}{\sum {W}_{i}} \qquad Equation 1$$

where Wᵢ is a scale value,

i is a variable identifying a particular suitability factor of a set of suitability factors considered for the assessment of the region, and

Sᵢ is the respective suitability value at a particular cell 212, and

and Wᵢ×Sᵢ is a weighted value for suitability factor i.

Equation 2 expresses Equation 1 using examples of weight values for 8 different suitability factors:

$$Composite {Suitability}_{cell} = \frac{( \begin{matrix}( 7 \times {S}_{Noise} ) + \\ ( 10 \times {S}_{Zoning} ) + \\ ( 10 \times {S}_{Power Grid} ) + \\ ( 10 \times {S}_{Schools} ) + \\ ( 8 \times {S}_{Train Stations} ) + \\ ( 8 \times {S}_{Hospitals} ) + \\ ( 10 \times {S}_{Fire Stations} ) + \\ ( 5 \times {S}_{Sport Venues} ) +\end{matrix} )}{( 7 + 10 + 10 + 10 + 8 + 8 + 10 + 5 )} \qquad Equation 2$$

As shown by Equation 2, each suitability factor may have a different weight value assigned thereto. The user may assign any weight to each suitability factor based on user preferences. Certain embodiments may enable a user to modify the weights assigned to one or more suitability factors by adjusting a user interface control, such as a slider. The user may be shown a user interface that displays the impact of the adjustment to the weight in real-time. Note that while 8 suitability factors are used in the example of Equation 2, embodiments of the invention may employ any number of suitability factors.

In operation according to an example embodiment, modeling component 122 assigns a numerical value for each suitability factor to each cell 212 based on the characteristics of the land bounded by that cell 212 for the suitability factor. For example, modeling component 122 may assess a particular cell 212 with the following numerical values:

| Suitability | Suitability |
|---|---|
| Factor | Value |
| Noise | 0.5 |
| Zoning | 0.3 |
| Power Grid | 0.6 |
| Schools | −0.8 |
| Train Stations | 0.5 |
| Hospitals | 0.7 |
| Fire Stations | 0.3 |
| Sports Venues | 0.1 |

Equation 3 below applies these suitability values into Equation 2:

$${CompositeSuitability}_{cell} = \frac{( \begin{matrix}( 7 \times 0.5 ) + \\ ( 10 \times 0.3 ) + \\ ( 10 \times 0.6 ) + \\ ( 10 \times - 0.8 ) + \\ ( 8 \times 0.5 ) + \\ ( 8 \times 0.7 ) + \\ ( 10 \times 0.3 ) + \\ ( 5 \times 0.1 ) +\end{matrix} )}{68} \\ = 0.26 \qquad Equation 3$$

While suitability values for the different suitability factors being considered are described herein as being composited using a weighted mean, it is understood by those with skill in the art that other mathematical, statistical, or optimization approaches, including considerations of sample variance, frequency weights, reliability weights, and facility location methods, can be employed without departing from the scope or spirit of the invention.

A particular cell 212 is identified as a candidate location for a vertiport if the weighted sum value for that cell 212 meets or exceed a configurable threshold value. For example, if a configurable threshold is established as 0.8, then in the example shown by Equation 3, the cell 212 having a sum of weighted values of 0.26 would not be represented by modeling component 122 as a candidate location. On the other hand, if the configurable threshold was 0.2 or if the characteristics of cell 212 were different such that the Composite Suitability met or exceeded 0.8, then in the example shown by Equation 3, the cell 212 would be represented by modeling component 122 as a candidate location since it has a lower sum of weighted values. If the suitability values differ at different points of time during the day, then this calculation may be repeated in accordance with those values to determine a cell's 212 suitability at those different times. This same approach also may accommodate changes in suitability due to weekend days, holidays, and so on. Indeed, the underlying reasons for the variation in suitability need not be known so long as the data evidencing the change in observed characteristics may be measured and subsequently reflected in a different suitability value.

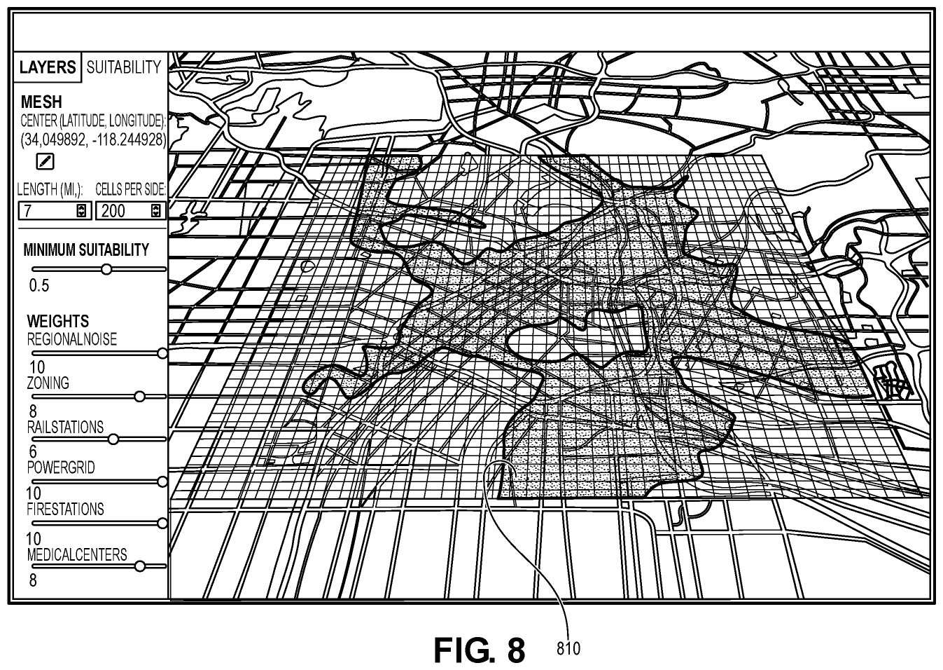

After making this determination for all cells 212 of grid 210, modeling component 122 may instruct the system to visually depict the set of candidate locations on user interface 200. For example, consider FIG. 8, which is an illustration of a user interface showing candidate locations in a geographical in accordance with an embodiment of the invention. In FIG. 8, adjacent cells 212 that qualify as candidate locations are identified in a candidate region 810.

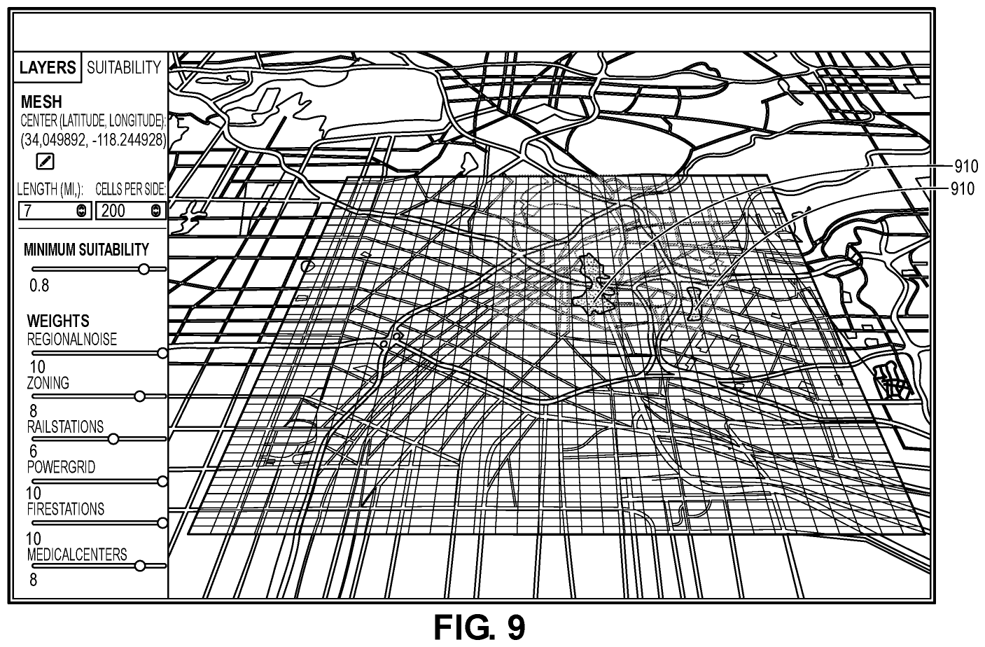

The suitability threshold value may be configured and adjusted by the user. If the suitability threshold value is raised, then one would anticipate the number of cells 212 that satisfy the new suitability threshold value would decrease, as evidenced by comparing candidate regions determined by the Minimum Suitability value of 0.5 chosen in FIG. 8 and Minimum Suitability value of 0.8 chosen in FIG. 9. FIG. 9 is an illustration of a user interface showing candidate locations in a geographical area that satisfy a higher suitability threshold value than FIG. 8 in accordance with an embodiment of the invention. In line with expectations, the number of cells 212 that satisfy the higher suitability threshold value in FIG. 9 is less than the number of cells 212 that satisfy the lower suitability threshold value in FIG. 8, as evidenced by the smaller size of candidate region 910 relative to candidate region 810.

After reviewing the locations of candidate locations displayed on the user interface, the user may identify one or more user-identified vertiport locations at which a vertiport is desired to be constructed by the user. These locations may be identified by latitude and longitude coordinates. It should be appreciated that the user-identified vertiport locations may be more granular in location than a cell 212. For example, a cell 212 may identify a small region of land, such as a city block or a square having each size about 55 meters or 185 feet in length, whereas the user-identified vertiport location corresponds to the exact location or building site within that cell 212 at which the vertiport may be constructed. The user-identified vertiport location may correspond to a particular location in a parking lot or even on top of a building.

For example, embodiments may consider the vertical height of buildings and may identify that the top of a tall building be deemed suitable as a candidate location. In doing so, the assessment of candidate location would involve considering constructing the vertiport on the top of the tall building, and so the height of the tall building would be an important identifying characteristic of that candidate location. Certain suitability factors, such as ground level noise, FAA restrictions, weather, and the like will be different at higher elevations compared to at ground level; thus, certain locations may be identified as a candidate location at a certain specified height but not at the same longitude and latitude coordinates at ground level.

To assist the user in identifying the user-identified vertiport locations, the user may cause modeling component 122 to update the user interface to depict the set of weighted values associated with a singular candidate location. For example, the values (or a subset thereof) may be depicted over a location identified by a mouse pointer, for example, upon detecting a hover or click on the candidate location. In this way, the user may view the underlying data supporting the suitability or non-suitability for a particular location.

Embodiments of the invention may also use a blacklist polygonal area, or simply a “blacklist,” to ensure that the area associated with certain cells 212 cannot be considered a candidate location. Any cell 212 that is present within the blacklist is not evaluated for consideration as a candidate location, as any cell 212 within the blacklist cannot be deemed a candidate location. Similarly, certain embodiments may also use a whitelist polygonal area, or simply a “whitelist,” to ensure that the area associated with certain cells 212 must be considered a candidate location. Only cells 212 that are present within the whitelist are evaluated for consideration as a candidate location, as any cell 212 deemed a candidate location must be within the whitelist.

### Simulating and Managing the use of Vertiports

In an embodiment, data identifying one or more user-identified vertiport locations may be input by modeling component 122 to simulation component 124. Simulation component 124 of an embodiment models and manages the flight paths of a plurality of modeled xAM vehicles, each of which is modeled in accordance with its specific performance characteristics, using the user-identified vertiport locations. In an embodiment, simulation component 124 may cause to be displayed on a user interface, to represent each xAM vehicle, an icon that depicts, identifies, or suggests characteristics of that xAM vehicle.

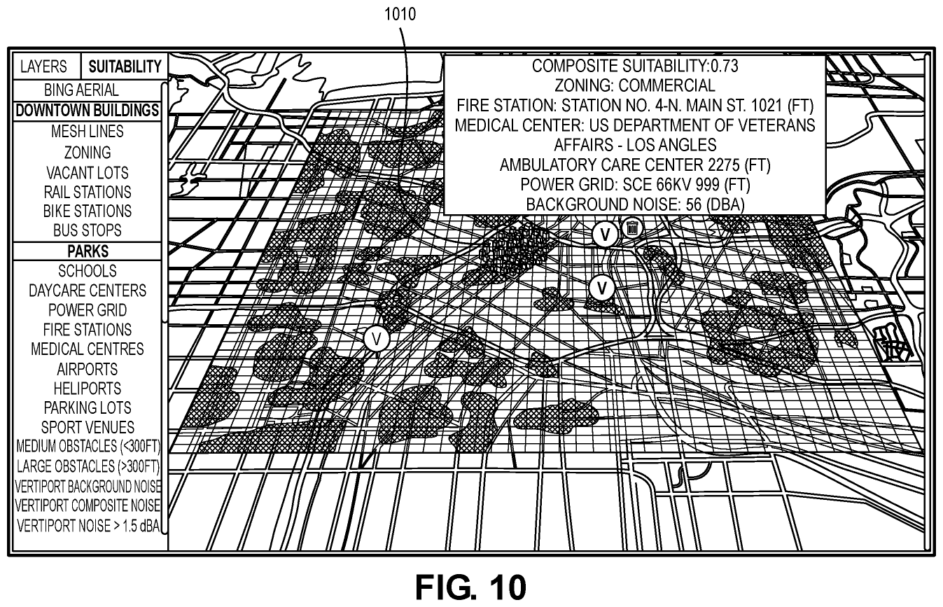

FIG. 10 is an illustration of a user interface employed by a simulation component 124 to analyze whether the flight paths of xAMs are obstructed in accordance with an embodiment of the invention. Static data source(s) 130 may store data that describes the three-dimensional landscape of the geographical area, including skyscrapers, mountains, and the like. FIG. 10 depicts three-dimensional representations 1010 of buildings and any obstacle that may be in the flight path of a xAM. While the user-identified vertiport locations may themselves be suitable to host a vertiport, there may be obstacles in a flight path to that vertiport which, when assessing potential use cases of the user-identified vertiport locations, may render that vertiport undesirable, or may require additional vertiport locations to be selected along the path. Simulation component 124 may identify those situations by assessing potential or likely flight paths of xAMs using the user-identified vertiport locations over the three-dimensional landscape.

In certain embodiments, static data source(s) 130 may store data describing Federal Aviation Administration (FAA) restrictions, FAA air corridors, local region zoning regulations for the geographical area, among others. In order to assess flight paths, machine learning techniques are utilized (1) to obtain conventional aircraft arrival/departure paths in and out of airports in the vicinity, and (2) to assess route structure around dynamic airspace constraints to obtain realistic flight routes. When modeling component 122 identifies a particular cell 212 as a candidate location, the assessment may include determining the suitability of FAA restrictions, FAA air corridors, and local region zoning regulations for that cell 212. However, certain analysis (e.g., noise footprint of vehicles) performed on anticipated flight paths to other vertiports may be subsequently performed by simulation component 124.

In an embodiment, after receiving, from modeling component 122, input identifying one or more user-identified vertiport locations, simulation component 124 may programmatically assess whether those user-identified vertiport locations are feasible based on information comprised within static data source(s) 130 and any other locations of nearby vertiports. If simulation component 124 determines that a particular user-identified vertiport location is not feasible, then simulation component 124 may update the visual display of a user interface to depict any constraint not satisfied by the user-identified vertiport location. For example, if a clear flight path cannot be established between an existing vertiport location and a new user-identified vertiport location, then this reason, and the location at which this condition is not satisfied (for example, the flight path and/or the location of an obstructing feature) is shown to the user on the user interface depicting the geographical area. Non-limiting, illustrative constraints include (a) a three-dimensional obstruction in a flight path originating or ending at the user-identified vertiport location, (b) a flight path originating or ending at the user-identified vertiport location having an unsupported length, and (c) a flight path that interferes with an existing FAA air corridor. Another illustrative example of a constraint is the identifying that a flight path traverses an area in which an endangered or protected species is present. Flight paths may be constrained to not exceed a certain length to allow for xAMs to possess enough power or fuel to safely make each flight.

As another example of a flight path constraint that may be enforced by simulation component 124, flight paths may be required in some circumstances to fly a path that follows roads, highways, or other man-made structures. This is so because xAM aircrafts flying over these areas would not contribute additional noise to the public beyond that already existing. Also, roads and highways are existing rights-of-way, and so there should be any new flight avoidance or flight interference issues with which to contend, as those have already been resolved.

Certain xAM vehicles may have a limit on how far they can safely fly before refueling or recharging. If the distance of the flight paths between vertiports exceeds this distance, then simulation component 124 may identify this constraint and suggest the addition of further vertiports to accommodate the supported range of the xAM vehicles anticipated to use the vertiports. Simulation component 124 may also consult with live data source(s) 140 as well as static data source(s) 130 to ensure other constraints can be satisfied by the flight paths of all xAM vehicles flying between actual and potential vertiports, such as without limitation, current and predicted wind speed, historical wind speed, current and predicted weather, noise footprint, battery usage, and so on.

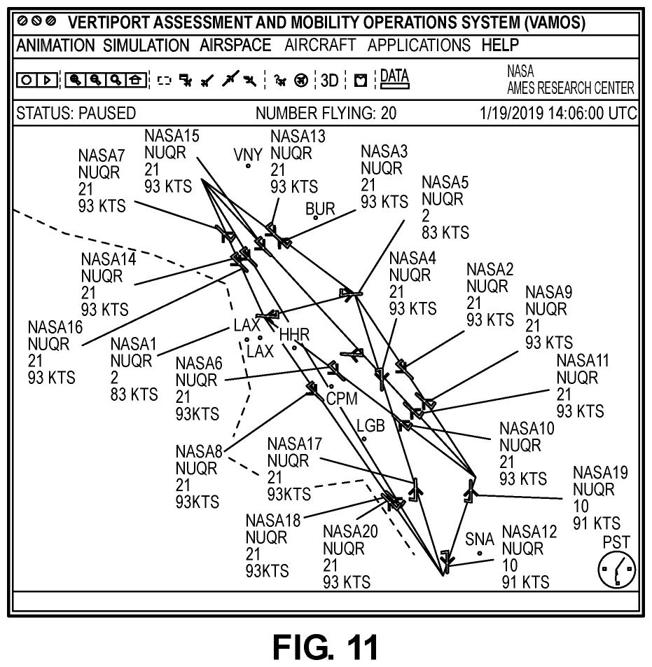

FIG. 11 is an illustration of a user interface employed by simulation component 124 that depicts the flight paths of xAMs in operation in accordance with an embodiment of the invention. Embodiments provide for simulation component 124 visually depicting, on a user interface showing a map or other representation of a geographical area, a present location and projected flight between of one or more xAM vehicles relative to the set of vertiports. One or more real-time operational behaviors of xAM vehicles may be depicted on the user interface, such as hovering, active obstacle avoidance procedures, a current noise footprint, a current estimate of battery usage, and a current measure of wind experienced by an xAM vehicle.

xAM vehicles may periodically perform hovering operations. Hovering may be performed to steady or ready the aircraft, to await clearance before proceeding with a landing operation or a glide slope descent or joining a specific path/corridor after departure, or to account for other air traffic, for example. Hovering, as can be appreciated, is fundamental to flow of traffic, as without hovering the adherence to safety protocols cannot be ensured. Thus, embodiments enable the proper monitoring of flight operating, such as operations, through the flight of xAM vehicles.

Advantageously, embodiments of the invention address an unaddressed need in the art by providing for identifying, in an automated fashion, one or more geographical locations suitable for a vertiport. Further, embodiments also provide for assessing the impact and use of potential and actual vertiport locations across geographical regions. The software and tools discussed herein enable city planners, vertiport developers, vehicle manufacturers, and the like to obtain greater insight into how to service their community and address the particular needs and features of the geographical area in which they serve.

### Implementing Mechanisms

FIG. 12 is a block diagram that illustrates a computer system 1200 upon which software performing one or more of the steps or functions discussed herein may be implemented. The computer system 1200 shown in FIG. 12 may be commercial-off-the-shelf (COTS) computer system or special purpose hardware.

In an embodiment, computer system 1200 includes processor 1204, main memory 1206, ROM 1208, storage device 1210, and communication interface 1218. Computer system 1200 includes at least one processor 1204 for processing information. Computer system 1200 also includes a main memory 1206, such as a random-access memory (RAM) or other dynamic storage device, for storing information and instructions to be executed by processor 1204. Main memory 1206 also may be used for storing temporary variables or other intermediate information during execution of instructions to be executed by processor 1204. Computer system 1200 further includes a read only memory (ROM) 1208 or other static storage device for storing static information and instructions for processor 1204. A storage device 1210, such as a magnetic disk or optical disk, is provided for storing information and instructions.

Embodiments of the invention may perform any of the actions described herein by computer system 1200 in response to processor 1204 executing one or more sequences of one or more instructions contained in main memory 1206. Such instructions may be read into main memory 1206 from another machine-readable medium, such as storage device 1210. Execution of the sequences of instructions contained in main memory 1206 causes processor 1204 to perform the process steps described herein. In alternative embodiments, hard-wired circuitry may be used in place of or in combination with software instructions to implement embodiments of the invention. Thus, embodiments of the invention are not limited to any specific combination of hardware circuitry and software.

The term “non-transitory computer-readable storage medium” as used herein refers to any non-transitory tangible medium that participates in storing instructions which may be provided to processor 1204 for execution. Note that transitory signals are not included within the scope of a non-transitory computer-readable storage medium. A non-transitory computer -readable storage medium may take many forms, including but not limited to, non-volatile media and volatile media. Non-volatile media includes, for example, optical or magnetic disks, such as storage device 1210. Volatile media includes dynamic memory, such as main memory 1206. Non-limiting, illustrative examples of computer -readable media include, for example, a floppy disk, a flexible disk, hard disk, magnetic tape, or any other magnetic medium, a CD-ROM, any other optical medium, a RAM, a PROM, and EPROM, a FLASH-EPROM, any other memory chip or cartridge, or any other medium from which a computer can read.

Various forms of computer-readable media may be involved in carrying one or more sequences of one or more instructions to processor 1204 for execution. For example, the instructions may initially be carried on a magnetic disk of a remote computer. The remote computer can load the instructions into its dynamic memory and send the instructions over a network link 1220 to computer system 1200.

Communication interface 1218 provides a two-way data communication coupling to a network link 1220 that is connected to a local network. For example, communication interface 1218 may be an integrated services digital network (ISDN) card or a modem to provide a data communication connection to a corresponding type of telephone line. As another example, communication interface 1218 may be a local area network (LAN) card to provide a data communication connection to a compatible LAN. Wireless links may also be implemented. In any such implementation, communication interface 1218 sends and receives electrical, electromagnetic, or optical signals that carry digital data streams representing various types of information.

Network link 1220 typically provides data communication through one or more networks to other data devices. For example, network link 1220 may provide a connection through a local network to a host computer or to data equipment operated by an Internet Service Provider (ISP).

Computer system 1200 can send messages and receive data, including program code, through the network(s), network link 1220 and communication interface 1218. For example, a server might transmit a requested code for an application program through the Internet, a local ISP, a local network, subsequently to communication interface 1218. The received code may be executed by processor 1204 as it is received, and/or stored in storage device 1210, or other non-volatile storage for later execution.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage, or attribute that is not expressly recited in a claim should limit the scope of such claim in any way. The specification and drawings are, accordingly, to be regarded in an illustrative rather than a restrictive sense.

What is claimed is:

1. One or more non-transitory computer-readable storage mediums storing one or more sequences of instructions for identifying one or more geographical locations suitable for a vertiport, which when executed by one or more processors, cause:
storing, in one or more digital data repositories, a plurality of data sets that describe a vertiport suitability of at least one suitability factor of a plurality of suitablity factors for a geographical area, including noise, zoning, power grid infrastructure, ground congestion, mass transit stations, hospitals, and fire stations;
processing the plurality of data sets to identify a set of candidate locations for a vertiport in the geographical area by:
(a) programmatically dividing the geographical area into a plurality of subregions,
(b) identifying one or more suitability factors in consideration for identifying the set of candidate locations,
(c) determining a composite value from a set of weighted values for each subregion of the plurality of subregions, wherein each weighted value in the set corresponds to a suitability value as scaled by a scale value for each of the suitability factors in consideration, wherein the suitability value is a reward value or a penalty value in the data sets, and
(d) identifying the particular subregion as one of the set of candidate locations if the composite value for the particular subregion exceeds a threshold value; and
outputting the set of candidate locations to be displayed on a user interface showing the geographical area.

2. The one or more non-transitory computer-readable storage mediums of claim 1, wherein each of the data sets that describe the vertiport suitability of the suitability factors includes a suitability function for determining a suitability value for the suitability factor for the particular subregion, wherein the suitability function associates a characteristic of the suitability factor with a particular suitability value.

3. The one or more non-transitory computer-readable storage mediums of claim 1, wherein the composite value is determined by taking a weighted mean of the suitability values for the one or more suitability factors in consideration for the subregion.

4. The one or more non-transitory computer-readable storage mediums of claim 1, wherein the set of candidate locations are used for one or more of a drone, a medical evacuation transport, a rescue transport, a cargo transport, and an airborne taxi or airborne personal vehicle.

5. The one or more non-transitory computer-readable storage mediums of claim 1, wherein the plurality of data sets further describe a vertiport suitability of of each of the following suitability factors for the geographical area: airports, airspace, arrival and departure paths, bike stations, bus stops, cellphone towers, convention centers, dams, daycare centers, and endangered species areas.

6. The one or more non-transitory computer-readable storage mediums of claim 1, wherein the plurality of data sets further describe a vertiport suitability of each of the following suitability factors for the geographical area: flood plain zones, heliports, helicopter routes, hurricane evacuation zones, evacuation routes, income data, land use, large obstacles, medium obstacles, military areas, mobility/multi-modal centers, and opportunity zones.

7. The one or more non-transitory computer-readable storage mediums of claim 1, wherein the plurality of data sets further describe a vertiport suitability of each of the following suitability factors for the geographical area: parking lots, parks, places of worship, police stations, ports, potential vertiport locations, population densities, power plants, reinvestment zones, schools, shopping malls, sidewalks, socioeconomic areas, sport venues, storm surge zones, streetcars, surface traffic, universities, vacant lots, water, and whitelist areas.

8. The one or more non-transitory computer-readable storage mediums of claim 1, wherein execution of the one or more sequences of instructions further cause:
receiving, from a user, longitude and latitude coordinates specifying a desired location for a vertiport, wherein said longitude and latitude coordinates are submitted by the user using the user interface that visually depicts the set of candidate locations.

9. The one or more non-transitory computer-readable storage mediums of claim 1, wherein visually depicting the set of candidate locations on the user interface comprises depicting, on the user interface, one or more candidate locations that are each comprised of adjacent candidate locations.

10. The one or more non-transitory computer-readable storage mediums of claim 1, wherein execution of the one or more sequences of instructions further cause:
in response to receiving input that selects a singular candidate location depicted on the user interface, updating the user interface to depict the set of weighted values for each suitability factor associated with said singular candidate location.

11. The one or more non-transitory computer-readable storage mediums of claim 1, wherein execution of the one or more sequences of instructions further cause:
in response to receiving input that changes the threshold value to an updated threshold value, updating the user interface to depict an updated set of candidate locations that satisfy the updated threshold value.

12. The one or more non-transitory computer-readable storage mediums of claim 1, wherein processing the plurality of data sets to identify the set of candidate locations for a vertiport launch pad in the geographical areas further comprises:
excluding one or more contiguous areas in said geographical area from consideration in determining the set of candidate locations such that all members of the set of candidate locations are external to said one or more contiguous areas.

13. The one or more non-transitory computer-readable storage mediums of claim 1, wherein identifying a particular subregion as a candidate location further comprises:
identifying a particular subregion as a candidate location only if said particular subregion is within one or more preidentified contiguous areas serving as a whitelist.

14. The one or more non-transitory computer-readable storage mediums of claim 1, wherein the plurality of data sets include a suitability data set that describes the three-dimensional landscape of the geographical area, and wherein identifying a particular subregion as a candidate location includes an assessment of the three-dimensional landscape within the geographical area for that particular subregion.

15. The one or more non-transitory computer-readable storage mediums of claim 1, wherein the plurality of data sets include a suitability data set that describes Federal Aviation Administration (FAA) restrictions, local region zoning regulations for the geographical area, and wherein identifying a particular subregion as a candidate location includes an assessment of the FAA restrictions and local region zoning regulations for anticipated flight paths within the geographical area to and from that particular subregion.

16. The one or more non-transitory computer-readable storage mediums of claim 1, wherein execution of the one or more sequences of instructions further cause:
visually depicting, on the map of the geographical area, a present location and projected flight between of one or more Air Mobility (xAM) vehicles relative to the set of candidate locations.

17. The one or more non-transitory computer-readable storage mediums of claim 1, wherein execution of the one or more sequences of instructions further cause:
visually depicting, on the map of the geographical area, one or more of a real-time operational behavior and a dynamic operational behavior of at least one of the one or more xAM vehicles.

18. The one or more non-transitory computer-readable storage mediums of claim 1, wherein said one or more real-time operational behaviors include hovering, active obstacle avoidance procedures, a current estimate of battery usage and noise footprint, and a current measure of wind and//or weather experienced by a xAM vehicle.

19. The one or more non-transitory computer-readable storage mediums of claim 1, wherein execution of the one or more sequences of instructions further cause:
in response to receiving, from a user, desired location for a vertiport, programmatically assessing whether the desired location is feasible based on information comprised within said plurality of data sets and any other locations of vertiports previously selected in said geographical area; and
in response to determining the desired location is not feasible, updating the visual display of the user interface to depict a constraint not satisfied by the desired location.

20. The one or more non-transitory computer-readable storage mediums of claim 19, wherein said constraint is (a) a three-dimensional obstruction in a flight path originating or ending at said desired location or (b) a flight path originating or ending at said desired location having an unsupported length.

21. An apparatus for identifying one or more geographical locations suitable for a vertiport, which when executed by one or more processors, comprising:
one or more processors; and
one or more non-transitory computer-readable storage mediums storing one or more sequences of instructions, which when executed, cause:
storing, in one or more digital data repositories, a plurality of data sets that describe a vertiport suitability of at least one suitability factor of a plurality of suitability factors for a geographical area, including noise, zoning, power grid infrastructure, ground congestion, mass transit stations, hospitals, and fire stations;
processing the plurality of data sets to identify a set of candidate locations for a vertiport in the geographical area by:
(a) programmatically dividing the geographical area into a plurality of subregions,
(b) identifying one or more suitability factors in consideration for identifying the set of candidate locations,
(c) determining a composite value from a set of weighted values for each subregion of the plurality of subregions, wherein each weighted value in the set corresponds to a suitability value as scaled by a scale value for each of the suitability factors in consideration, wherein the suitability value is a reward value or a penalty value in the data sets, and
(d) identifying the particular subregion as one of a set of candidate locations if the composite value for the particular subregion exceeds a threshold value; and
outputting the set of candidate locations to be displayed on a user interface showing the geographical area.

22. A method for identifying one or more geographical locations suitable for a vertiport, comprising:
storing, in one or more digital data repositories, a plurality of data sets that describe a vertiport suitability of at least one suitability factor of a plurality of suitability factors for a geographical area, including noise, zoning, power grid infrastructure, ground congestion, mass transit stations, hospitals, and fire stations;
processing the plurality of data sets to identify a set of candidate locations for a vertiport in the geographical area by:
(a) programmatically dividing the geographical area into a plurality of subregions,
(b) identifying one or more suitability factors in consideration for identifying the set of candidate locations,
(c) determining a composite value from a set of weighted values for each subregion of the plurality of subregions, wherein each weighted value in the set corresponds to a suitability value as scaled by a scale value for each of the suitability factors in consideration, wherein the suitability value is a reward value or a penalty value in the data sets, and
(d) identifying the particular subregion as one of a set of candidate locations if the composite value for the particular subregion exceeds a threshold value; and
outputting the set of candidate locations to be displayed on a user interface showing the geographical area.
